(19) United States
(12) Patent Application Publication
(10) Pub. No.: US 2019/0139466 A1
(43) Pub. Date: May 9, 2019

(54) APPARATUS FOR SIGNALING A ROADSIDE EMERGENCY

(71) Applicant: David Christopher Dennis Lester, Aldergrove (CA)

(72) Inventor: David Christopher Dennis Lester, Aldergrove (CA)

(21) Appl. No.: 15/804,205

(22) Filed: Nov. 6, 2017

(51) Int. Cl. G09F 17/00

(52) U.S. Cl. CPC G09F 17/00; G09F 2017/0075

(57) ABSTRACT

An apparatus includes an elongate member, a plurality of markings, and a plurality of attachment means. The elongate member includes a first-side and a second-side. Each side includes words to alert other drivers and emergency service. The plurality of markings are disposed about a surface area of the elongate member to provide a visual indicator. The plurality of attachment means are configured to attach the elongate member to a vehicle. The apparatus may be used to signal the roadside emergency by providing a highly visible safety sign or banner for applying to a vehicle.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of signs and banners and more specifically relates to traffic warning signs.

### 2. Description of Related Art

Travel on interstate highways requires that automobiles travel at a relatively high rate of speed. It is often necessary that the driver of a vehicle on such a highway be alert for unexpected occurrences on the roadway ahead. One type of unexpected occurrence is the disabled vehicle along the side of the highway, or in some cases, in the middle of the high speed lane of the roadway. It is not always possible for the driver of an oncoming vehicle to discern whether the vehicle on the shoulder is moving or standing still, until he realizes that he is approaching the vehicle at a relatively fast closing rate. Thus, he is forced to maneuver at the last minute, since he could not determine the state of the vehicle in time for a judicious lane change. Also, at high rates of speed, it is difficult for the passing motorist to tell whether the driver of the stopped vehicle is merely resting or in need of help. Therefore, it would be desirable to have a distress warning device which unmistakably indicates to oncoming traffic that a distress condition exists, so that such oncoming traffic can have sufficient time to take corrective action and obtain help when necessary. A suitable solution is desired.

U.S. Pat. No. 5,398,437 to Elmer R. Bump, Jr. relates to a warning device for vehicles and the like. The described warning device for vehicles and the like includes a warning device for vehicles that are stopped whereby there may be danger of collision with another moving vehicle and danger of personal injury of such a moving vehicle. The present invention relates to a safety banner device for use in combination with a vehicle or the elements of nature. The safety banner device according to this invention would contain: a) foldable material; b) at least one magnet embedded in the light weight material thereby allowing the material to be affixed to a metal surface; c) at least one warning symbol made of a reflective material whereby being visible to people when lights would shine on the banner, and wherein d) the banner is capable of being folded up several times or rolled up whereby it is capable of being stored into a small container.

### BRIEF SUMMARY OF THE INVENTION

In view of the foregoing disadvantages inherent in the known signs art, the present disclosure provides a novel apparatus for signaling a roadside emergency. The general purpose of the present disclosure, which will be described subsequently in greater detail, is to provide a safety and warning device for signaling drivers and others to improve safety.

An apparatus for signaling a roadside emergency is disclosed herein. The apparatus for signaling a roadside emergency includes an elongate member, a plurality of markings, and a plurality of attachment means. The elongate member has a first-side and a second-side. The plurality of markings is disposed about a surface area of the elongate member and configured to provide a visual indicator. The plurality of attachment means is configured to attach the elongate member to a vehicle. One of the plurality of attachment means is located on a left-portion of the elongate member and another of the plurality of attachment means is located on a right-portion of the elongate member. The apparatus is configured to signal drivers during a roadside emergency.

The apparatus includes a reversible safety sign which may be configured to be used with a safety vest. The apparatus structured to be placed on a back side of the vehicle to allow oncoming traffic to see the vehicle. The first-side includes a first-word such as “Caution”. The second-side includes a second-word such as “Help”. The plurality of markings comprises a plurality of reflective lines. The elongate member is made of a reflective material to allow visibility of the elongate member at night. The plurality of attachment means includes a plurality of magnets or other suitable fasteners.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for signaling a roadside emergency, constructed and operative according to the teachings of the present disclosure.

FIG. 1 is a perspective view of the apparatus for signaling a roadside emergency during an ‘in-use’ condition, according to an embodiment of the disclosure.

FIG. 2 is a perspective view of the apparatus for signaling a roadside emergency of FIG. 1, according to an embodiment of the present disclosure.

FIG. 3 is a perspective view of the apparatus for signaling a roadside emergency of FIG. 1, according to an embodiment of the present disclosure.

FIG. 4 is a perspective view of the apparatus for signaling a roadside emergency of FIG. 1, according to an embodiment of the present disclosure.

FIG. 5 is a perspective view of the apparatus for signaling a roadside emergency of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to signs and banners and more particularly to an apparatus for signaling a roadside emergency as used to improve warning signs and methods of warning other drivers with signs or banners.

Generally, the present invention is a device which may be stored locally in a personal or professional vehicle. The banner may be pre-printed on two sides in high visibility contrasting reflectivity. One side reads “Caution”, to be left on the traffic facing side of the vehicle, with the other side reading “Help” if the driver and occupants are remaining near the vehicle. The driver/passenger can apply to vehicle in low light or virtually any other road conditions to improve visibility to oncoming traffic. Additionally, first responders will attend the scene faster and reduce the chance of failing to find the stranded vehicle/motorists. This device may be magnetic.

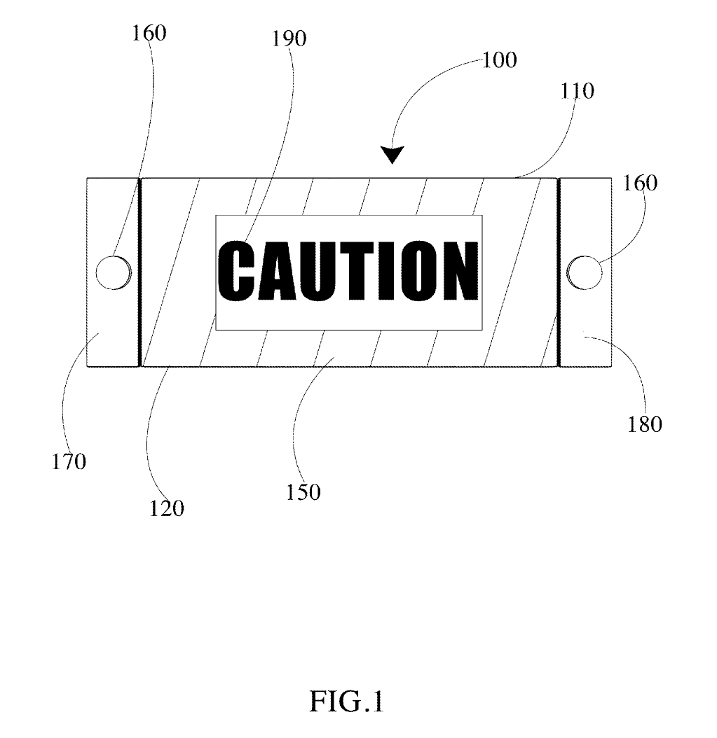

Referring now more specifically to the drawings by numerals of reference, there is shown in FIGS. 1-5, various views of an apparatus for signaling a roadside emergency 100. FIG. 1 shows an apparatus for signaling a roadside emergency 100 during an ‘in-use’ condition, according to an embodiment of the present disclosure. As illustrated, the apparatus for signaling a roadside emergency 100 may include an elongate member 110, a plurality of markings 140, and a plurality of attachment means 160.

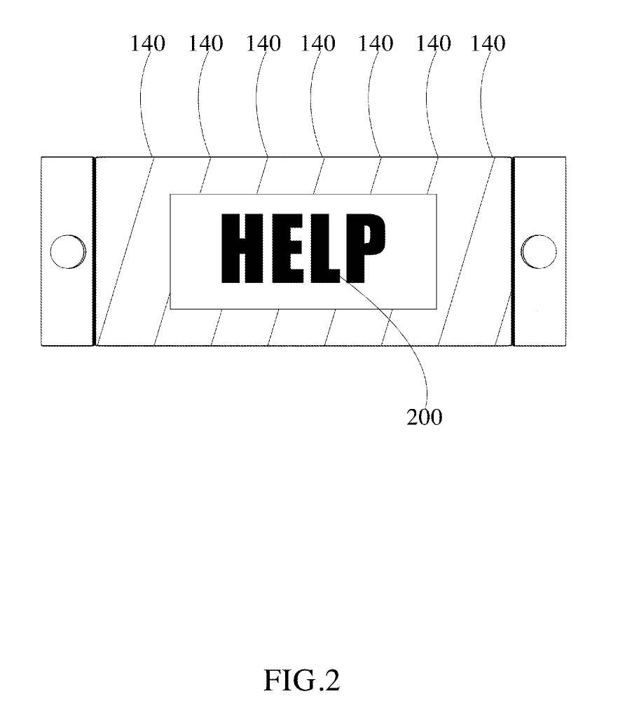

FIG. 2 shows a perspective view of the apparatus for signaling a roadside emergency 100 of FIG. 1, according to an embodiment of the present disclosure. The elongate member 110 of the present invention includes a first-side 120 and a second-side 130. The plurality of markings 140 are disposed about a surface area 150 of the elongate member 110 and configured to provide a visual indicator. The plurality of attachment means 160 are configured to attach the elongate member 110 to a vehicle 20. One of the plurality of attachment means 160 is located on a left-portion 170 of the elongate member 110 and another of the plurality of attachment means 160 is located on a right-portion 180 of the elongate member 110. The apparatus is configured to signal the roadside emergency by providing a highly visible safety sign or banner for applying to a vehicle 20.

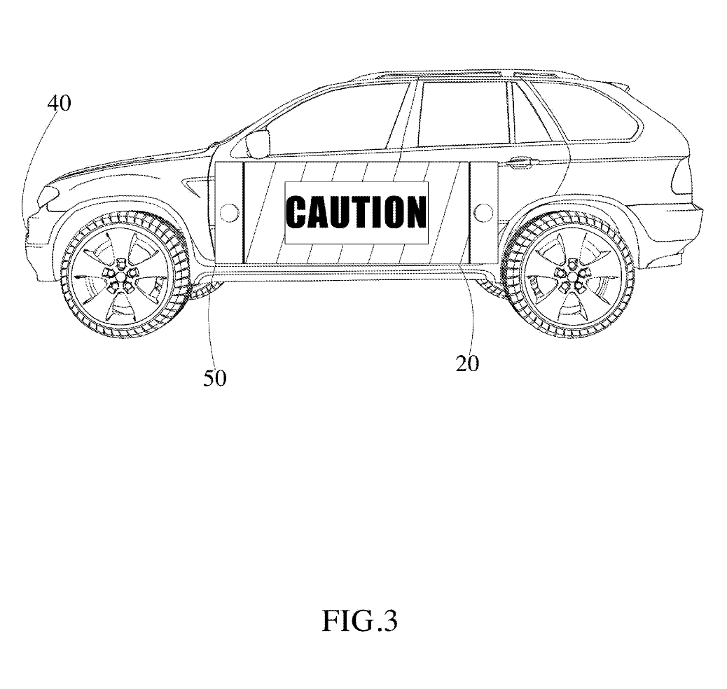

FIG. 3 shows a perspective view of the apparatus for signaling a roadside emergency 100 of FIG. 1, according to an embodiment of the present disclosure. As above, the apparatus for signaling a roadside emergency 100 may include a safety sign or banner. The apparatus is configured to be used with a safety vest. The apparatus is configured to be placed on a back side 30 of the vehicle 20 to allow oncoming traffic to see the vehicle 20. The apparatus is configured to be placed on a front side 40 of the vehicle 20 to allow oncoming traffic to see the vehicle 20. The apparatus may also be placed on a left-side 50 of the vehicle or a right-side 60 of the vehicle 20. The plurality of attachment means 160 may include a plurality of magnets or other suitable fasteners.

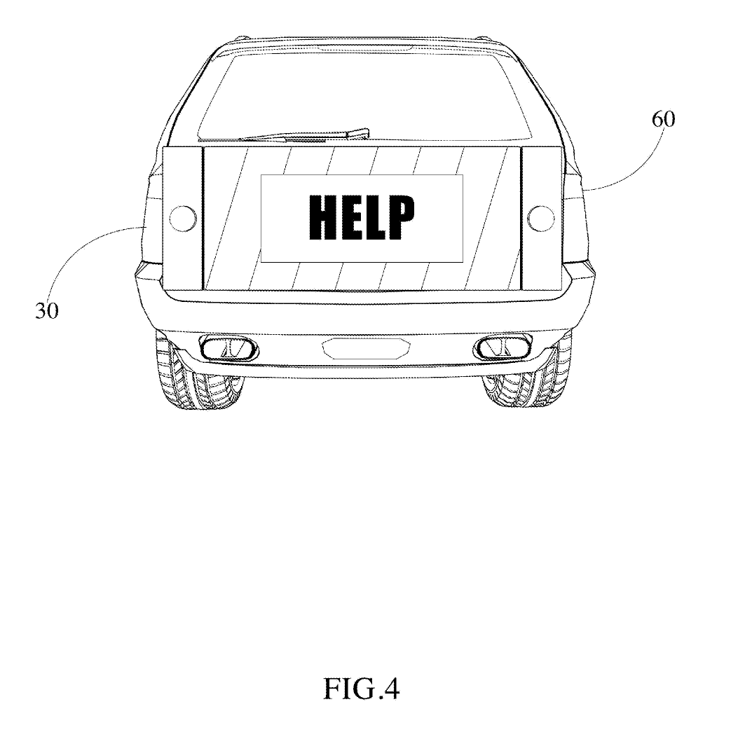

FIG. 4 shows a perspective view of the apparatus for signaling a roadside emergency 100 of FIG. 1, according to an embodiment of the present disclosure. As above, the apparatus for signaling a roadside emergency 100 may include the elongate member 110 having the first-side 120 and the second-side 130. In a preferred embodiment, the first-side 120 includes a first-word 190, “Caution”. The first-side 120 may be positioned facing oncoming traffic. The second-side 130 includes a second-word 200, “Help”. The second-side 130 may be used if the driver and occupants are remaining near the vehicle 20. The plurality of markings 140 comprises a plurality of reflective lines for high visibility. The elongate member 110 is made of a reflective material to allow visibility of the elongate member 110 at night. The device is visible during low-light or other road conditions.

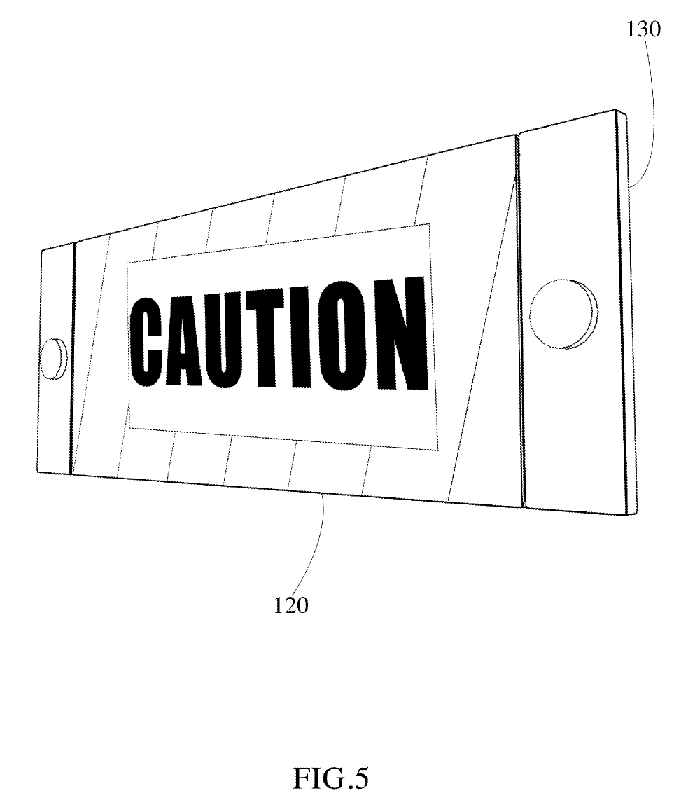

FIG. 5 shows another perspective view of the apparatus for signaling a roadside emergency 100 of FIG. 1, according to an embodiment of the present disclosure. As above, the apparatus for signaling a roadside emergency 100 may include the elongate member 110 having the first-side 120 and the second-side 130. The apparatus 100 is provided to be used as a warning sign or banner for alerting drivers and emergency services. The device is reversible and includes reflective material for high visibility. Various combinations for functional indicia may be used.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for signaling a roadside emergency comprising:
an elongate member, said elongate member having a first-side and a second-side;
a plurality of markings, said plurality of markings disposed about a surface area of said elongate member and configured to provide a visual indicator;
a plurality of attachment means, one of said plurality of attachment means located on a left-portion of said elongate member and another of said plurality of attachment means located on a right-portion of said elongate member;
wherein said plurality of attachment means is configured to attach said elongate member to a vehicle; and
wherein said apparatus is configured to signal said roadside emergency.

2. The apparatus for signaling a roadside emergency of claim 1, wherein said apparatus is a safety sign.

3. The apparatus for signaling a roadside emergency of claim 1, wherein said apparatus is a banner.

4. The apparatus for signaling a roadside emergency of claim 1, wherein said apparatus is configured to be used with a safety vest.

5. The apparatus for signaling a roadside emergency of claim 1, wherein said apparatus is configured to be placed on a back side of said vehicle to allow oncoming traffic to see said vehicle.

6. The apparatus for signaling a roadside emergency of claim 1, wherein said apparatus is configured to be placed on a front side of said vehicle to allow oncoming traffic to see said vehicle.

7. The apparatus for signaling a roadside emergency of claim 1, wherein said apparatus is configured to be placed on a left-side of said vehicle.

8. The apparatus for signaling a roadside emergency of claim 1, wherein said apparatus is configured to be placed on a right-side of said vehicle.

9. The apparatus for signaling a roadside emergency of claim 1, wherein said first-side includes a first-word acting in a capacity of functional indicia.

10. The apparatus for signaling a roadside emergency of claim 1, wherein said second-side includes a second-word acting in a capacity of functional indicia.

11. The apparatus for signaling a roadside emergency of claim 9, wherein said first-word is caution.

12. The apparatus for signaling a roadside emergency of claim 10, wherein said second-word is help.

13. The apparatus for signaling a roadside emergency of claim 1, wherein said plurality of markings comprises a plurality of reflective lines.

14. The apparatus for signaling a roadside emergency of claim 1, wherein said elongate member is made of a reflective material to allow visibility of said elongate member at night.

15. The apparatus for signaling a roadside emergency of claim 1, wherein said plurality of attachment means includes a plurality of magnets.

16. An apparatus for signaling a roadside emergency, said apparatus comprising:
an elongate member, said elongate member having a first-side and a second-side;
a plurality of markings, said plurality of markings disposed about a surface area of said elongate member configured to provide a visual indicator;
a plurality of attachment means, one of said plurality of attachment means located on a left-portion of said elongate member and another of said plurality of attachment means located on a right-portion of said elongate member;
wherein said plurality of attachment means is configured to attach said elongate member to a vehicle;
wherein said apparatus is configured to signal said roadside emergency;
wherein said apparatus is a safety sign;
wherein said apparatus is configured to be used with a safety vest;
wherein said apparatus is configured to be placeable on a back side of said vehicle to allow oncoming traffic to see said vehicle;
wherein said first-side includes a first-word;
wherein said second-side includes a second-word;
wherein said first-word is caution;
wherein said second-word is help;
wherein said plurality of markings comprises a plurality of reflective lines;
wherein said elongate member is made of a reflective material to allow visibility of said elongate member at night; and
wherein said plurality of attachment means includes a plurality of magnets.
